(19) United States
(12) Patent Application Publication
(10) Pub. No.: US 2025/0278708 A1
(43) Pub. Date: Sep. 4, 2025

(54) OPTIMIZING BATCH BILL PAYMENT

(71) Applicant: The PNC Financial Services Group, Inc., Pittsburgh, PA (US)

(72) Inventors: Howard Forman, Fort Lauderdale, FL (US); Robert May, McMurray, PA (US); Janice Gill, Baton Rouge, LA (US); Jason Plotner, Pittsburgh, PA (US); Susan Beard, Raleigh, NC (US)

(21) Appl. No.: 18/594,838

(22) Filed: Mar. 4, 2024

(51) Int. Cl. G06Q 20/10; G06Q 20/02; G06Q 20/14

(52) U.S. Cl. CPC G06Q 20/102; G06Q 20/023; G06Q 20/14

(57) ABSTRACT

Disclosed is a system and method to perform payments from a customer to a payee. The system includes a computer-implemented payment server system including a payment scheduling system including a web-based interface to receive payment data, an intelligent routing module to schedule a payment based on the payment data, and a payment staging engine to perform the scheduled payment. The payment server system is to receive, by the web-based interface, payment data for one or more payments. The payment server system is further to determine payment scheduling data for each of the one or more payments. The payment scheduling data includes a determination whether the payment can be made by a requested payment date and a preferred payment network. The payment server system is to transmit payment for each actionable payment via a preferred payment network for each actionable payment.

### BACKGROUND

Banks often provide corporate banking platforms to corporate clients of the banks. Such corporate banking platforms allows corporate clients to manage their receivables and disbursements.

### SUMMARY

In one general aspect, the present invention is directed to computer-implemented systems and methods for online banking, including optimizing initiating payments for a customer of a financial institution. The system according to various embodiments of the present invention comprises a computer-implemented payment server system of the financial institution. The payment server system can comprise: a payment scheduling system comprising a web-based interface to receive payment data; an intelligent routing module to schedule a payment based on the payment data; and a payment staging engine to perform the scheduled payment. The payment server system is configured to receive, by the web-based interface, from a customer of the financial institution that has an account with the financial institution, payment data for one or more payments to be made by the customer from the account, where the payment data for the one or more payments comprises, for each of the one or more payments, a payee, a payment amount, and a requested payment date.

The payment server system is further configured to determine, by the intelligent routing module, payment scheduling data for each of the one or more payments, where the payment scheduling data comprises for each of the one or more payments: a determination whether the payment can be made by the requested payment date; and a preferred payment network for the payment based on data regarding the payee and the requested payment date.

The payment server system is further configured to transmit, by the intelligent routing module, actionable payments of the one or more payments based on the payment scheduling data to the payment staging engine, where the actionable payments comprise payments that can be made by the requested payment date.

The payment server system is further configured to transmit, by the payment staging engine, payment for each of the actionable payments via the preferred payment network for the actionable payment.

The payment server system of the present invention can, in various embodiments, provide a payment for a customer of the financial institution, where the payment is based on when the payment can be received by a payee. The payment server system can automatically provide an earliest payment date for a customer based on the information the payment server system has for the customer. This reduces the burden on the customer having to know the payment network and in some instances the payee routing information and the payee account information. For example, a customer can provide a routing number and account number for the payee or a mailing address for the payee and the payment server system can determine an earliest payment date for the customer. For some payee's the payment server system can determine the payee routing information and payee account information based on the mailing address of the payee. These and other benefits of the present invention will be apparent from the description that follows.

### BRIEF DESCRIPTION OF THE DRAWINGS

The various aspects described herein, both as to organization and methods of operation, together with further objects and advantages thereof, may best be understood by reference to the following description, taken in conjunction with the accompanying drawings as follows.

FIG. 1 illustrates an example schematic of a payment server system of a financial institution, in accordance with at least one aspect of the present disclosure.

FIG. 2 illustrates a view of an example web-based interface for a customer to enter individual payments, in accordance with at least one aspect of the present disclosure.

FIG. 3 illustrates a view of an example web-based interface for a customer to upload a file that includes one or more payments, in accordance with at least one aspect of the present disclosure.

FIG. 4 illustrates a view of an example web-based interface for a customer to create a template for reading file uploads, in accordance with at least one aspect of the present disclosure.

FIG. 5 illustrates a view of an example web-based interface for displaying actionable and non-actionable payments, in accordance with at least one aspect of the present disclosure.

FIG. 6 illustrates a method that can be executed by a control circuit to schedule payments for a customer, in accordance with at least one aspect of the present disclosure.

FIG. 7 illustrates a method that can be executed by a processor to route payments for a customer based on a requested payment date, in accordance with at least one aspect of the present disclosure.

FIG. 8 illustrates an example method to determine a preferred payment network, in accordance with at least one aspect of the present disclosure.

FIG. 9 illustrates a method that can be executed by a processor to transmit payments for a customer, in accordance with at least one aspect of the present disclosure.

Corresponding reference characters indicate corresponding parts throughout the several views. The exemplifications set out herein illustrate various disclosed embodiments, is one form, and such exemplifications are not to be construed as limiting the scope thereof in any manner.

### DETAILED DESCRIPTION

Sending payments can be a hassle for a customer of a financial institution, where the customer needs to know the payment network, payee routing information, and payee account information. The different payment networks (e.g. automated clearing house (ACH) payment, same day automated clearing house (SDA) payment, real-time payments (RTP), etc.) each have different limitations around timing, required information, and whether the payee is eligible for that network. For example, some payees can receive payments via the RTP network and others cannot and are only eligible for ACH payments. In most instances, the customer does not care what payment network is used and only wants to get a payment to a payee on time from one of the customer's accounts at the financial institution. As such, there is a need for a system that can ease the burden from the customer to allow the customer to make payments easier.

One solution is to develop a payment server system that can provide a payment for a customer of the financial institution, where the payment is based on when the payment can be received by a payee. The payment server system can automatically provide an earliest payment date for a customer based on the information the payment server system has for the customer. In some aspects, the customer provides the payee information in regard to payment instructions. For example, the customer can provide the payees routing and account numbers, the payees address, or if neither is known the customer can search a database of payees for the payee. In some aspects, the individual payments can be entered into a web-based interface by the customer. In an alternative aspect, the customer can upload a file that includes one or more payments, where the file corresponds to a template created by the customer. The payments can then be transmitted to an intelligent routing module that determines the earliest payment date and if the requested payment date is possible and the appropriate payment network to use. Once approved by the customer, the payments can be executed on the requested payment date.

The payment server system can be a benefit to the customer. For example, it provides the customer with an earliest payment date and automatically selects the best payment network for each payment that the customer provides. It also allows a customer to schedule bulk payments without needing to input a payment network.

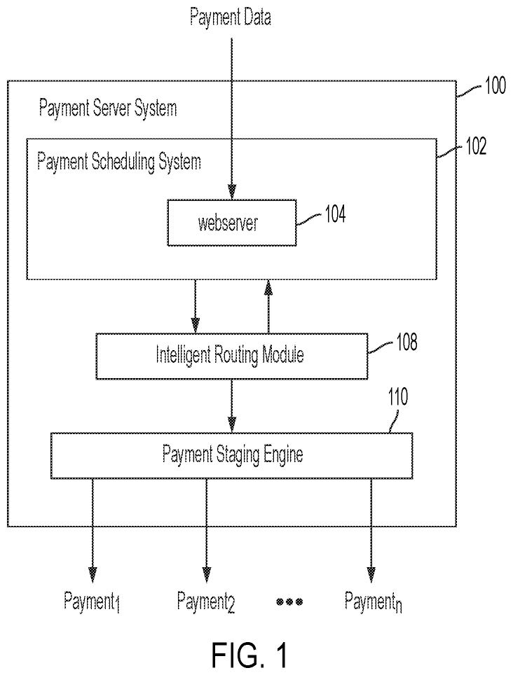

FIG. 1 illustrates an example schematic of a payment server system 100 of a financial institution, in accordance with at least one aspect of the present disclosure. The payment server system 100 includes a payment scheduling system 102, an intelligent routing module 108, and a payment staging engine 110. The payment scheduling system 102 includes a webserver 104 that provides a web interface to a customer of the financial institution. The customer has one or more accounts with the financial institution. The customer can access the web-based interface through any general computing device that can access an internet network (e.g. a phone, tablet, computer, etc.). The customer can input payment data into the web interface which transmits the payment data to the webserver 104. The webserver 104 includes at least one processor coupled to at least one memory, where the memory stores instructions that are executed by the processor to perform the operations of the payment scheduling system 102. The payment scheduling system 102 is communicably coupled to the intelligent routing module 108.

The customer inputs payment data for one or more payments into a web-based interface for a payment scheduling system 102. The payment data is then transmitted to the webserver 104 of the payment scheduling system 102. The payment data includes at least a payee, a payment amount, an account with the financial institution to pay from, and a requested payment date for each payment. In some aspects, the payee can be an account number and routing number or an address for the payee. If the payee is an address, then the payment scheduling system 102 can determine if there is an account number and routing number associated with the address. If the customer does not know an account and routing number or an address for the payee, then in some aspects, the customer can search a database of payees for a specific payee. In various aspects, the customer provides at least one type of payee information before a payment can be made.

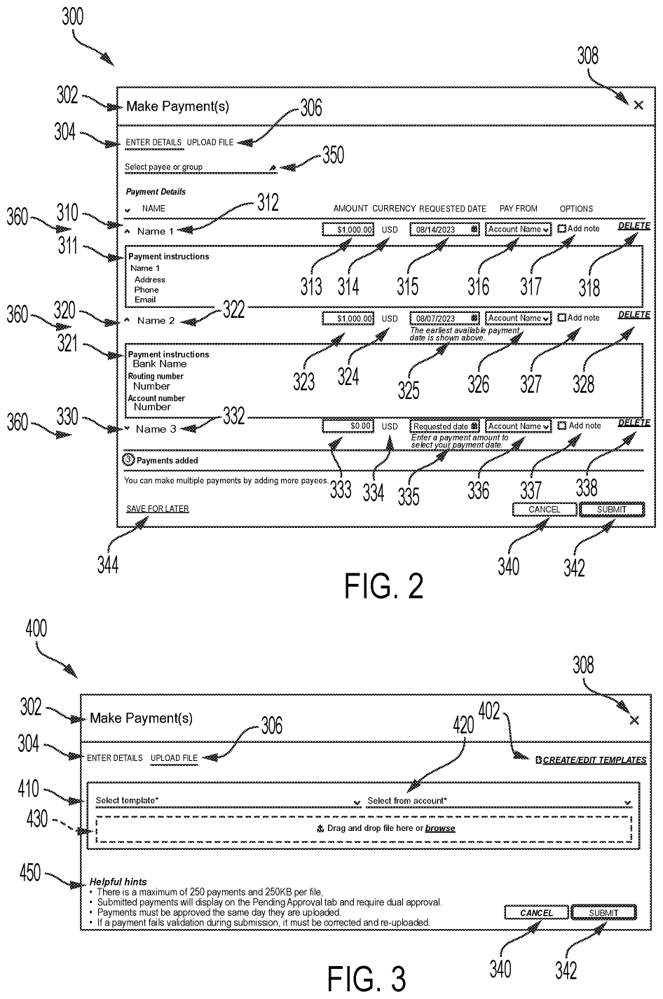

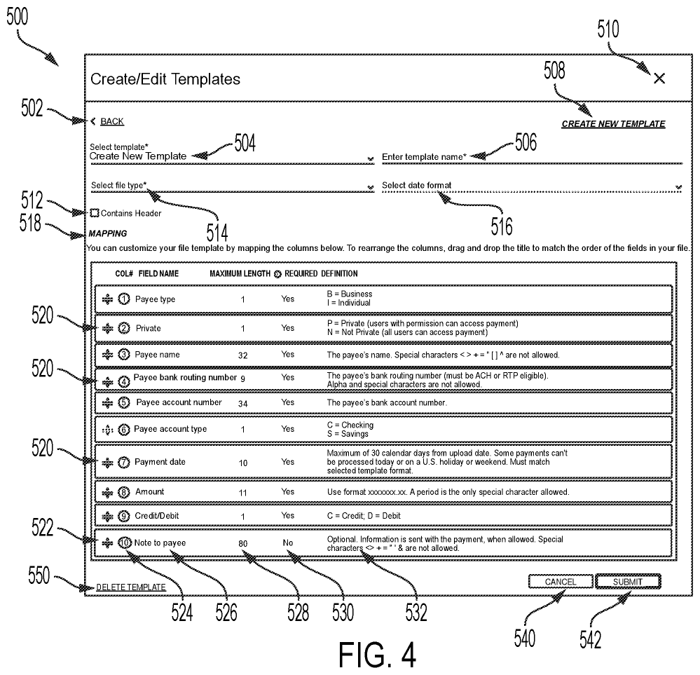

The payment data can be entered into the web-based interface in multiple ways. In one aspect, the payment data for each payment is entered individually into the web-based interface, as discussed further in regard to FIG. 2. In this aspect, the payment scheduling system 102 formats the entered payment data to be transmitted to the intelligent routing module 108. In an alternative aspect, a file containing the payment data is uploaded to the web-based interface and transmitted to the webserver 104, as discussed further in regard to FIGS. 3 and 4. The payment scheduling system 102 can match the file with a template to read the payment data in the file. Once the payment data is read, the payment scheduling system 102 formats the entered payment data to be transmitted to the intelligent routing module 108.

The intelligent routing module 108 includes at least one processor coupled to at least one memory, where the memory stores instructions that are executed by the processor to perform the operations of the intelligent routing module 108. In at least one aspect, the intelligent routing module 108 determines payment scheduling data for each of the one or more payments. The payment scheduling data includes a determination whether the payment can be made by the requested payment date, and a preferred payment network for the payment based on data regarding the payee and the requested payment date. For example the intelligent routing module 108 can determine if a payment can be made by a requested payment date and determine a preferred payment network to be used for the payment. The intelligent routing module 108 is communicably coupled to the payment staging engine 110.

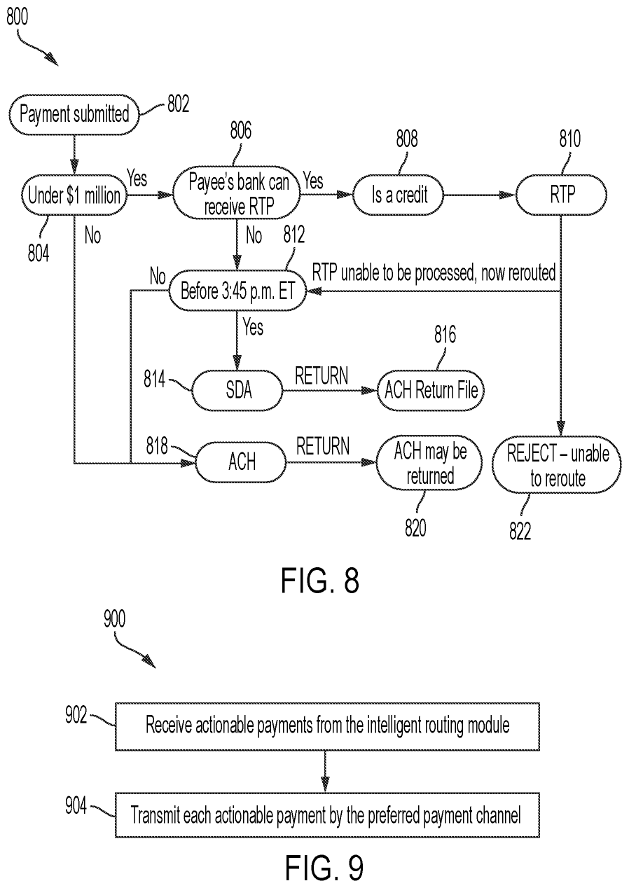

The intelligent routing module 108 receives the payment data from the payment scheduling system 102. In some aspects, a processor of the intelligent routing module 108 can execute a method (e.g. method 800, FIG. 8) to generate an earliest possible payment date based on a payee and a payment amount. In some alternative aspects, a processor of the payment scheduling system 102 can execute the method. The method includes the processor receiving the payment amount and the payee information for a payment from the payment scheduling system 102. The method further includes the processor determining an earliest payment date for the payment. In some aspects, the earliest payment date is determined by the payment network that can be used. The payment network that can be used can be based on the time of submission of the payment, the payee, and/or the amount of the payment. The method further includes the processor transmitting the earliest payment date to the payment scheduling system 102. The payment scheduling system 102 can then provide the earliest payment date to the customer through the web-based interface. For example, the customer can enter a payee and an amount for a payment into the web-based interface and the payment scheduling system 102 can provide an earliest possible payment date to the customer through the web-based interface. In one aspect, the earliest possible payment date is determined by the intelligent routing module 108. In an alternative aspect, the earliest possible payment date is determined by the payment scheduling system 102. In some aspects, the payment scheduling system 102 will not allow a customer to enter a requested payment date earlier than the earliest possible payment date.

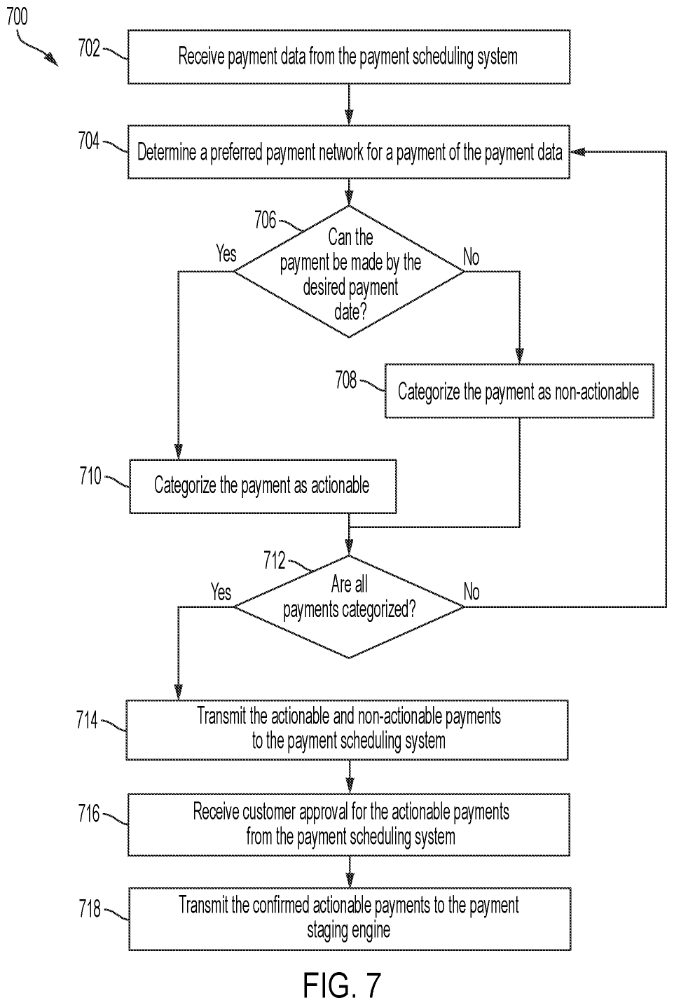

In some aspects, the intelligent routing module 108 receives all the payment data for each payment at once. For example, the intelligent routing module 108 receives a payee, a payment amount, a requested payment date for each payment, and a payment account to pay from. A processor of the intelligent routing module 108 can then execute a method (e.g. method 700, FIG. 7) to determine actionable payments and non-actionable payments based on the payment data. In this method, the intelligent routing module 108 determines an earliest possible payment date for each payment. The intelligent routing module 108 then compares the earliest possible payment date to the requested payment date and determines if the payment can be made by the requested payment date and the preferred payment network to make the payment. If the payment can be made by the requested payment date, then the intelligent routing module 108 categorizes the payment as an actionable payment. If the payment cannot be made by the requested payment date, then the intelligent routing module 108 categorizes the payment as a non-actionable payment.

In some aspects, the intelligent routing module 108 transmits the actionable payments and the non-actionable payments to the payment scheduling system 102. The customer can then approve the actionable payments through the web-based interface for payment. The payment scheduling system 102 transmits the approved actionable payments to the intelligent routing module 108. The intelligent routing module then transmits the approved actionable payments to the payment staging engine 110. In some aspects, the intelligent routing module 108 transmits the actionable payments to the payment staging engine 110 without any further edits from the customer. If the customer changes the payment data of an actionable payment, then the intelligent routing module 108 receives that new payment data and determines if the payment is actionable or non-actionable as discussed above.

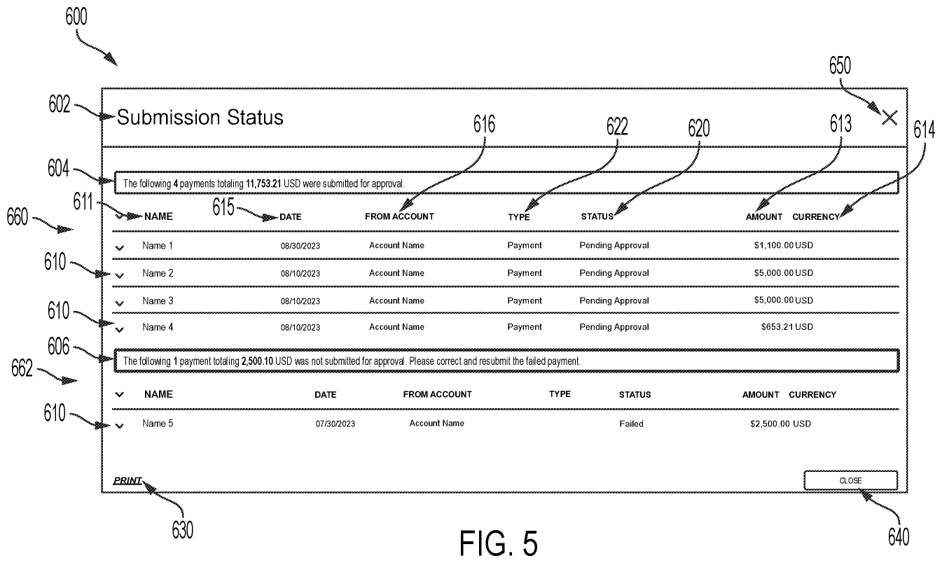

In some aspects, the actionable payments and the non-actionable payments are displayed on the web-based interface for the customer to view, as discussed in regard to FIG. 5. The web-based interface can provide a status for each of the payment, where the status can be based on the payment network being used for the payment. For example, some example statuses for actionable payments can be “pending approval” (e.g. the payment can be made by the requested payment date and is waiting on the customer's final approval of the payment), “pending” (e.g. waiting for the payment to be made on the requested payment date), or “payment transmitted” (e.g. the payment has been sent to the payee). An example status for a non-actionable payment is “failed” (e.g. the payment cannot be made by the requested payment date).

The customer can upload new payment data for any non-actionable payments. The payment scheduling system 102 can then format the new payment data and transmit it to the intelligent routing module 108, where the intelligent routing module can determine if the updated payment is an actionable payment or a non-actionable payment.

The payment staging engine 110 includes at least one processor coupled to at least one memory, where the memory stores instructions that are executed by the processor to perform the operations of the payment staging engine 110. The payment staging engine 110 receives the actionable payments from the intelligent routing module 108. The payment staging engine 110 transmits each payment through the preferred payment network for that payment. Each payment is transmitted by the payment staging engine 110 at the appropriate time such that the payment is received by the payee on the requested payment date. The payment staging engine 110 can transmit any number of payments to any number of payees on the same or different days.

FIG. 2 illustrates a view of an example web-based interface 300 for a customer to enter individual payments (e.g. payments 310, 320, 330), in accordance with at least one aspect of the present disclosure. The web-based interface 300 includes a title 302, an exit button 308 to close the web-based interface 300, a save button 344 to save the web-based interface 300, a cancel button 340 to cancel the current payments, and a submit button 342 to submit the current payments to the webserver 104. The web-based interface 300 further includes tabs 304, 306 that allow the customer to switch between entering details tab 304 and an upload file tab 306. The web-based interface 300 shows an example of the entering details tab 304. FIG. 3 illustrates web-based interface 400 showing an example of the upload file tab 306.

Referring to FIG. 2, the customer can select payee's with the search bar 350. The customer can then select a payee that the customer has previously uploaded. For example, a customer can use a different web-based interface to input payment instructions for a payee so that the customer can later make payments to the payee. In some aspects, the customer can provide a payee and the financial institution can search for payment information for that payee. For example, the financial institute can find payment information for a payee that the customer has paid in the past. Additionally, if the customer has not provided the payment information for the payee previously, then the customer can search for the payee in a database of payee's. If the customer cannot find the payee in the database, then the customer will have to contact the payee for payment information. Once the customer selects the payee, a payment row 360 is generated for the payee.

The web-based interface 300 shows the customer entering three payees to generate three payment rows 360. Each payment row 360 is for a payment (e.g. payments 310, 320, 330) and includes a payee name (e.g. payee name 312, 322, 332), payee instructions (e.g. payee instructions 311, 321), an amount to pay the payee (e.g. amounts 313, 323, 333), a currency for the payment (e.g. currencies 314, 324, 334), a requested payment date (e.g. requested payment dates 315, 325, 335), a customer account to pay from (e.g. customer accounts 316, 326, 336), a notes boolean (e.g. notes booleans 317, 327, 337), and a delete button to remove the payment (e.g. delete button 318, 328, 338). The first payment 310 is fully filled out with payment data. The web-based interface 300 is displaying the earliest possible payment date for the requested payment date 325 of the second payment 320. The web-based interface 300 is displaying for the customer that a requested payment date 335 cannot be selected until an amount 333 is entered for the payment 330. For example, as discussed above, after the payee and payment amount are entered, the payment scheduling system 102 can communicate with the intelligent routing module 108 to determine an earliest payment date that can be displayed for the customer. By displaying the earliest possible payment date for the customer, the customer can determine an appropriate date to select for the payment. Additionally, each payment can be made in a different manner and/or payment network. For example, the first payment 310 is being mailed to an address and the second payment 320 is being transferred to a bank account at a financial institution.

The submit button 342 is initially disabled. Once all the payment data for each payment is entered, then the submit button 342 is enabled to allow the customer to submit the requested payments.

FIG. 3 illustrates a view of an example web-based interface 400 for a customer to upload a file that includes one or more payments, in accordance with at least one aspect of the present disclosure. The web-based interface 400 similar to the web-based interface 400 includes a title 302, an exit button 308 to close the web-based interface 400, a cancel button 340 to cancel the current payments, and a submit button 342 to submit the current payments to the webserver 104. The web-based interface 400 further includes tabs 304, 306 that allow the customer to switch between entering details tab 304 and an upload file tab 306. The web-based interface 400 shows an example of the uploading file tab 306. The web-based interface 400 further includes a file drop location 430 and a hints section 450. The file drop location 430 is a location on the web-based interface 400 that a payments file can be dropped. The customer can also use the browse button in the file drop location 430 to select the file. The hints section 450 provides the customer with instructions for the file upload.

In at least one aspect, web-based interface 400 can be used by a customer to bulk upload payments. For example, a customer can upload a file that contains a list of requested payments. The payment server system 100 can then determine whether each payment can be made by the requested payment date and a payment network to use for each payment. For example, the payment server system 100 can categorize the requested payments into actionable payments that can be made by the requested payment date and non-actionable payments that cannot be made by the requested payment date. For example, some requested payments cannot be made due to the payment server system 100 not being able to find the payee or the payment cannot be made by the requested payment date with any of the payment networks for the payee. The payment server system 100 can transmit a report of the actionable and non-actionable payments to a web-based interface (e.g. web-based interface 600, FIG. 5) for the user to view. The user can then provide updated payment information for any non-actionable payments and the payment server system 100 can determine whether the updated payments can be made by the new requested payment date and a payment network to use for each of these payments.

In at least one aspect, the uploaded file is matched with a template file to allow the payment scheduling system 102 to read the payment data from the file. The data in the uploaded file can then be formatted and transmitted to the intelligent routing module 108. In this aspect, the web-based interface 400 further includes a template selection list 410, an account to pay from list 420, and a create/edit template button 402. The user can then select an account the customer has with the financial institution from the account to pay from list 420. This account will be where the payments are withdrawn from. The user can then select a template from the template selection list 410. The customer can create the templates with a template builder on a web-based interface (e.g. web-based interface 500, FIG. 4) and save them on their account with the payment server system 100. The create/edit template button 402 can open a web-based interface (e.g. web-based interface 500, FIG. 4) to allow the customer to create/edit templates saved on their account with the payment server system 100. After the customer saves a template, that template will appear on the template selection list 410. This allows the customer on the web-based interface 400 to select a template that corresponds to the file to be uploaded. The customer can then browse their computer for the payment data file or drag and drop the payment file in the web-based interface 400 at location 430.

The submit button 342 is initially disabled. Once the template is selected, the pay from account is selected, and the payment file is uploaded, then the submit button 342 is enabled to allow the customer to submit the requested payments in the payment file.

FIG. 4 illustrates a view of an example web-based interface 500 for a customer to create a template for reading file uploads, in accordance with at least one aspect of the present disclosure. The web-based interface 500 provides the customer with a template builder to allow the customer to create their own template for an upload file. The customer is provided with the required payment information. Then using the web-based interface 500, the customer can specify how they would like to construct their template (e.g. column ordering, specifying a delimiter, header information, date format). Once the template is filled out and saved, the customer can upload a payment file conforming to the template in the web-based interface 400. The payment scheduling system 102 can then read the uploaded file based on the selected template, as discussed in regard to FIG. 3. The payment scheduling system 102 can then transmit the read payment data from the file to the intelligent routing module 108 as discussed in regard to FIG. 1.

The web-based interface 500 includes a close button 510, a back button 502, a select template list 504, a create new template button 508, a template name 506, a file type list 514, a select date format list 516, a file header boolean 512, an instructions section 518, rows 520 containing the required payment information, a delete template button 550, a cancel button 540, and a submit button 542. The close button 510 allows the customer to close/exit the web-based interface 500. The create new template button 508 allows the customer to create a new template. The back button 502 allows the customer to go to the previously opened web-based interface. The select template list 504 allows the customer to select a template to edit. The template name 506 allows the customer to name the template. The file type list 514 allows the customer to select the type of file to be uploaded (e.g. excel, comma separated variable (csv), etc.). The type of file allows the customer to specify the delimiter being used in the payment file to be uploaded. The select date format list 516 allows the customer to specify the date format for the requested payment date (e.g. month/day/year, year/month/date, etc.). The file header boolean 512 allows the customer to specify if the file to be uploaded will have a header or not. The delete template button 550 allows the customer to delete the currently selected template. The cancel button 540 allows the customer to cancel the creation of a new template or cancel any edits made to the currently selected template. The submit button 542 allows the customer to save the new template or save the edits to a selected template.

The instructions section 518 can provide the customer with instructions for how to customize the template. The web-based interface 500 provides the customer with the required payment information. The required payment information is shown as a plurality of rows 520. The different rows 520 specify the payment data that the customer needs to have for each requested payment in the file to be uploaded. Each row 520 has a column number 524, a field name 526, a maximum length 528, a required boolean 530, and a definition 532. The field name 526 specifies the information that the customer has to have in the payment file to be uploaded. The column number 524 specifies what column in the payment file the data for the field name 526 will appear. The column number 524 can be reordered as the customer desires to move the rows 520. For example, the customer can select the row 520 at location 522 and move the row up and down changing the column number for the row 520. This allows the customer to customize the column order for the data in the payment file. For example, the customer can move the row 520 regarding the field name 526 “payee name” to be the first column. This would mean that the data regarding “payee name” will be located in the first column of the file to be uploaded. The maximum length 528 specifies the maximum number of characters that can be in each column of the payment file. The required boolean 530 informs the customer if data for the column number 524 is required for the payment to be scheduled and paid. The definition 532 provides the customer with the format that is required for the data in each field name. For example, the definition 532 states that the field name 526 “payee type” needs to be a “B” for business or an “I” for individual. Any other characters but “I” or “B” in the specified column number 524 for the field name 526 “payee type” will result in an error and the payment not being scheduled.

The intelligent routing module 108 receives formatted payment data from the payment scheduling system 102. As discussed in regard to FIG. 1, the intelligent routing module 108 can executes a method (e.g. method 700, FIG. 7) to determine actionable payments and non-actionable payments based on the formatted payment data. The intelligent routing module 108 can then transmit the actionable and non-actionable payments to the payment scheduling system 102. The payment scheduling system 102 can show the actionable and non-actionable payments on a web-based interface.

FIG. 5 illustrates a view of an example web-based interface 600 for displaying actionable and non-actionable payments, in accordance with at least one aspect of the present disclosure. The web-based interface 600 includes a title 602, a close button 650, a close button 640, a print button 630, an actionable payments section 660, and a non-actionable payments section 662. The close button 640 and the close button 650 allow the customer to close the web-based interface 600. The print button 630 allows the customer to print a report of the actionable payments and non-actionable payments.

The actionable payments section 660 includes a summary section 604 and any number of payments 610. The summary section 604 includes the total number of actionable payments and the total amount of the actionable payments. The non-actionable payments section 662 includes a summary section 606 and any number of payments 610. The summary section 606 includes the total number of non-actionable payments and the total amount of the non-actionable payments. Each payment in either the actionable payment section 660 or the non-actionable payment section 662 includes a name 611, a requested payment date 615, a pay from account 616, a type 622, a payment status 620, and amount 613, and a currency 614. In some aspects, the name 611 is the payee name. The requested payment date 615 is the date the customer requested the payment to be made. The pay from account 616 is an account the customer has with the financial institution. Each payment can be from a different account. The type 622 is the payment network that is being used. For example, the type 622 can initially read “payment” and after the payment is fully processed by the payment server system 100, the type 622 will be updated with the network that is being used for the payment. The payment status 620 provides the customer with the status of the payment. The status can be based on the payment network being used for the payment. For example, some example statuses for actionable payments can be “pending approval” (e.g. the payment can be made by the requested payment date and is waiting on the customer's final approval of the payment, “pending” (e.g. waiting for the payment to be made on the requested payment date), or “payment transmitted” (e.g. the payment has been sent to the payee). An example status of a non-actionable payment is “failed.”

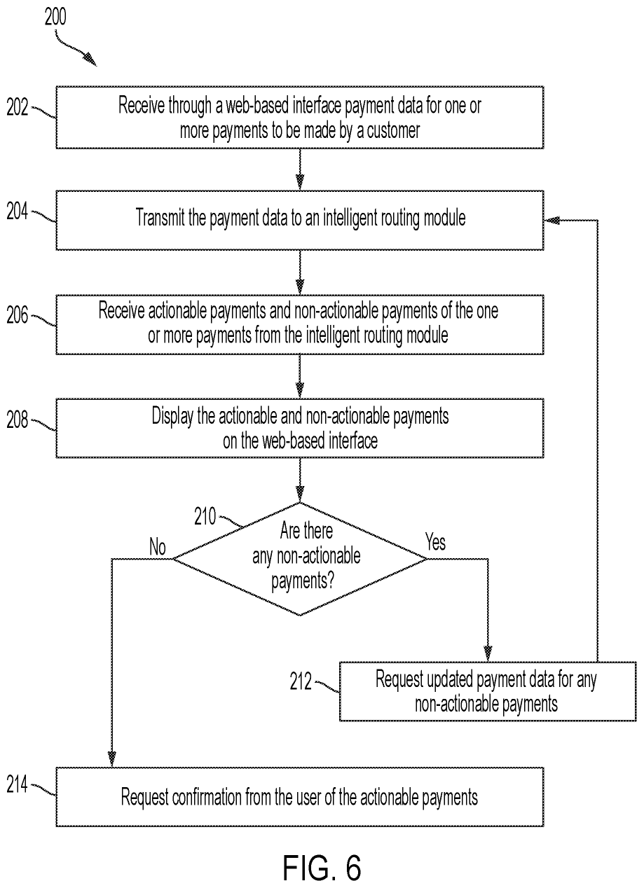

FIG. 6 illustrates a method 200 that can be executed by a processor (e.g. the processor of the webserver 104) to schedule payments for a customer, in accordance with at least one aspect of the present disclosure. The method 200 includes the processor receiving 202 through a web-based interface payment data for one or more payments to be made by a customer. In one aspect, the payment data is entered directly into the web-based interface. In an alternative aspect, the processor reads the payment data from a file by using a template. The method 200 further includes 204 the processor transmitting 204 the payment data to an intelligent routing module (e.g. intelligent routing module 108).

The method 200 further includes the processor receiving 206 actionable payments and non-actionable payments of the one or more payments from the intelligent routing module. The method 200 further includes the processor displaying 208 the actionable and non-actionable payments on the web-based interface. The method 200 further includes the processor determining 210 if there any non-actionable payments. If there are non-actionable payments, the method 200 proceeds along the “yes” branch. The method 200 further includes the processor requesting 212 updated payment data for any non-actionable payments. The updated payment data can then be transmitted to the intelligent routing module and updated and the method 200 can cycle through 204 to 208 for the updated payment data. If there are no non-actionable payments, the method 200 proceeds along the “no” branch. The method 200 further includes the processor requesting 214 approval or confirmation from the user of the actionable payments. The approval or confirmation of the actionable payments can then be transmitted to the intelligent routing module.

FIG. 7 illustrates a method that can be executed by a processor (e.g. the processor of the intelligent routing module 108) to route payments for a customer based on a requested payment date, in accordance with at least one aspect of the present disclosure. The method 700 further includes the processor receiving 702 payment data from a payment scheduling system (e.g. payment scheduling system 102). In at least one aspect, the payment data includes a payee, a requested payment date, a payment amount, and an account of the customer to pay from. The method 700 further includes the processor determining 704 a preferred payment network for a payment of the payment data. In at least one aspect, the preferred payment network is the chosen based on the earliest possible payment date. In some aspects, the preferred payment network is selected based on the payee. For example, some payee's can only receive payment through a specific payment networks and not others. In at least one aspect, the preferred payment network is selected through the method 800 shown in FIG. 8.

The method 700 further includes the processor determining 706 if the payment can be made by the requested payment date. The earliest possible payment date can be determined by the selection of the preferred payment network. For example, the earliest possible payment date is based on the possible payment networks that can be used for a payment. The requested payment date can be compared to the earliest possible payment date to determine if the payment can be made by the requested payment date. If the payment cannot be made by the requested payment date, the method 700 proceeds along the “no” branch. The method 700 further includes the processor categorizing 708 the payment as non-actionable. If the payment cannot be made by the requested payment date, the method 700 proceeds along the “yes” branch. The method 700 further includes the processor categorizing 710 the payment as actionable.

The method 700 further includes the processor determining 712 if all the payments have been categorized. If there is a remaining payment to be categorized, then the method 700 proceeds along the “no” branch and the method 700 cycles until all the payments are categorized. If all the payments have been categorized, then the method 700 proceeds along the “yes” branch. The method 700 further includes the processor transmitting 714 the actionable and non-actionable payments to the payment scheduling system. In at least one aspect, the customer can confirm the actionable payments through the web-based interface of the payment scheduling system. The method 700 further includes the processor receiving 716 customer approval for the actionable payments from the payment scheduling system. The method 700 further includes the processor transmitting 718 the confirmed actionable payments to a payment staging engine (e.g. payment staging engine 110).

FIG. 8 illustrates a method 800 that can be used to determine a preferred payment network, in accordance with at least one aspect of the present disclosure. In one aspect, the payment is submitted 802 to the intelligent routing module 108. The payment includes an amount, a date, and a time of the payment submission. In one aspect, the method 800 can be use by the intelligent routing module 108. In an alternative aspect, the method can be used by the payment scheduling system 102. The method 800 includes a processor determining 804 if the payment amount is under one million dollars. If the payment is over one million dollars, the method 800 proceeds along the “no” branch and the processor selects ACH as the preferred payment network 818. If the payment is under one million dollars, the method 800 proceeds along the “yes” branch.

The method 800 further includes the processor determining 806 if the Payee's bank can receive RTP. If the payee's bank can receive RTP, the method 800 proceeds along the “yes” branch. The method 800 further includes the processor determining 808 if the payment is a credit payment. If the payment is a credit payment (as opposed to a debit payment, for example) the processor selects 810 RTP for the payment network. The manner in which the RTP payment is performed is different if the payment is a credit payment or another form of payment (e.g. a debit payment). In some alternative aspects, a debit payment can be processed. If an RTP payment is not able to be processed then the method 800 further includes the processor rerouting the payment and proceeds to the processor determining 812 if the payment was submitted before 3:45 pm ET. If the payment cannot be rerouted, then the method 800 proceeds to the processor rejecting 822 the payment where the payment was unable to be rerouted. If the payee's bank cannot receive RTP, the method 800 proceeds to the processor determining 812 if the payment was submitted before 3:45 pm ET.

If the payment was submitted before 3:45 pm ET, the method 800 proceeds along the “yes” branch. The method 800 further includes the processor selecting 814 SDA for the payment network. The method 800 further includes receiving 816 an ACH return file. For example, the payment receiving financial institute can reject the payment (e.g. if the receiving account was closed, etc.) and transmit back an ACH return file. The payment can then be recredited back to the customer's account based on the ACH return file. If the payment was submitted on or after 3:45 pm ET, the method 800 proceeds along the “no” branch. The method 800 further includes the processor selecting 818 ACH as the preferred payment network. The method 800 further includes the processor receiving 820 a return of the ACH. Similar to the above, the payment receiving financial institute can reject the payment (e.g. if the receiving account was closed, etc.) and transmit back an ACH return file. The payment can then be recredited back to the customer's account based on the ACH return file.

FIG. 9 illustrates a method 900 that can be executed by a processor (e.g. a processor of the payment staging engine 110) to transmit payments for a customer, in accordance with at least one aspect of the present disclosure. The method 900 further includes the processor receiving 902 actionable payments from the intelligent routing module (e.g. intelligent routing module 108). The method 900 further includes the processor transmitting 904 each actionable payment by the selected preferred payment network. The payments can be pending in the payment staging engine the payments are each transmitted based on the requested payment date and the preferred payment network. For example, a payment being made weeks in the future can remaining pending in the payment staging engine and only be transmitted at the time needed for the payment to reach the payee on the requested payment date.

In one general aspect, the present invention is directed to a method including receiving, by a web-based interface of a computer-implemented payment scheduling system of a financial institution, from a customer of the financial institution that has an account with the financial institution, payment data for one or more payments to be made by the customer from the account. The payment data for the one or more payments includes, for each of the one or more payments: a payee, a payment amount, and a requested payment date. The method further includes determining, by an intelligent routing module, payment scheduling data for each of the one or more payments, wherein the intelligent routing module is communicably coupled to the payment scheduling system. The payment scheduling data includes for each of the one or more payments: a determination whether the payment can be made by the requested payment date, and a preferred payment network for the payment based on data regarding the payee and the requested payment date. The method further includes transmitting, by the intelligent routing module, actionable payments of the one or more payments based on the payment scheduling data to a payment staging engine. The actionable payments include payments that can be made by the requested payment date. The method further includes transmitting, by the payment staging engine, payment for each of the actionable payments via the preferred payment network for the actionable payment.

In another general aspect, the present invention is directed to a system, including a computer-implemented payment server system of a financial institution. The payment server system includes a payment scheduling system comprising a web-based interface to receive payment data, an intelligent routing module to schedule a payment based on the payment data, and a payment staging engine to perform the scheduled payment. The intelligent routing module is communicably coupled to the payment scheduling system. The payment server system is to receive, by the web-based interface, from a customer of the financial institution that has an account with the financial institution, payment data for one or more payments to be made by the customer from the account. The payment data for the one or more payments includes, for each of the one or more payments: a payee, a payment amount, and a requested payment date. The payment server system is further to determine, by the intelligent routing module, payment scheduling data for each of the one or more payments. The payment scheduling data includes for each of the one or more payments: a determination whether the payment can be made by the requested payment date, and a preferred payment network for the payment based on data regarding the payee and the requested payment date. The payment server system is further to transmit, by the intelligent routing module, actionable payments of the one or more payments based on the payment scheduling data to the payment staging engine. The actionable payments include payments that can be made by the requested payment date. The payment server system is further to transmit, by the payment staging engine, payment for each of the actionable payments via the preferred payment network for the actionable payment.

In various aspects, the intelligent routing module transmits, to the web-based interface, non-actionable payments of the one or more payments, wherein non-actionable payments comprise payments that cannot be made by the requested payment date.

In various aspects, the payment server system is further to receive, by the web-based interface, updated payment data for each non-actionable payment of the one or more payments from the customer, wherein the updated payment data includes updated payments to be made by the customer from the account. The payment server system is further to determine, by the intelligent routing module, updated payment scheduling data based on the updated payment data. The payment server system is further to transmit, by the intelligent routing module, actionable payments of the updated payments to the payment staging engine. The payment server system is further to transmit, by the payment staging engine, payment for each of the actionable payments of the updated payments via the preferred payment network for the actionable payment of the updated payments.

In various aspects, the payment server system is further to transmit, by the web-based interface to the intelligent routing module, customer approval of the payments of the actionable payments.

In various aspects, the customer provides payment data for one or more payments by entering information into payment data fields in the web-based interface. In various aspects, the web-based interface receives a payee for a payment and a payment amount for the payment. In various aspects, the web-based interface displays, in response to receiving the payee and the payment amount, the earliest available payment date.

In various aspects, the customer provides payment data for one or more payments by uploading a file to the web-based interface, wherein the file comprises payment data for the one or more payments. In various aspects, the web-based interface receives the file from the customer. In various aspects, the customer creates a template on the web-based interface, and the file is uploaded with a format that matches the template.

In various aspects, the preferred payment network is one of a plurality of payment networks including real-time payment, same day automated clearing house payment, and automated clearing house payment.

While several forms have been illustrated and described, it is not the intention of Applicant to restrict or limit the scope of the appended claims to such detail. Numerous modifications, variations, changes, substitutions, combinations, and equivalents to those forms may be implemented and will occur to those skilled in the art without departing from the scope of the present disclosure. Moreover, the structure of each element associated with the described forms can be alternatively described as a means for providing the function performed by the element. Also, where materials are disclosed for certain components, other materials may be used. It is therefore to be understood that the foregoing description and the appended claims are intended to cover all such modifications, combinations, and variations as falling within the scope of the disclosed forms. The appended claims are intended to cover all such modifications, variations, changes, substitutions, modifications, and equivalents.

The foregoing detailed description has set forth various forms of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

As used in any aspect herein, the term “control circuit” may refer to, for example, hardwired circuitry, programmable circuitry (e.g., a computer processor including one or more individual instruction processing cores, processing unit, processor, microcontroller, microcontroller unit, controller, digital signal processor (DSP), programmable logic device (PLD), programmable logic array (PLA), or field programmable gate array (FPGA)), state machine circuitry, firmware that stores instructions executed by programmable circuitry, and any combination thereof. The control circuit may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc. Accordingly, as used herein “control circuit” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

As used in any aspect herein, the terms “component,” “system,” “module” and the like can refer to a control circuit computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the foregoing disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

What is claimed is:

1. A method comprising:
receiving, by a web-based interface of a computer-implemented payment scheduling system of a financial institution, from a customer of the financial institution that has an account with the financial institution, payment data for one or more payments to be made by the customer from the account, wherein the payment data for the one or more payments comprise, for each of the one or more payments:
a payee;
a payment amount; and
a requested payment date;
determining, by an intelligent routing module, payment scheduling data for each of the one or more payments, wherein the intelligent routing module is communicably coupled to the payment scheduling system, wherein the payment scheduling data comprises for each of the one or more payments:
a determination whether the payment can be made by the requested payment date; and
a preferred payment network for the payment based on data regarding the payee and the requested payment date;
transmitting, by the intelligent routing module, actionable payments of the one or more payments based on the payment scheduling data to a payment staging engine, wherein the actionable payments comprise payments that can be made by the requested payment date; and
transmitting, by the payment staging engine, payment for each of the actionable payments via the preferred payment network for the actionable payment.

2. The method of claim 1, further comprising transmitting, by the intelligent routing module to the web-based interface, non-actionable payments of the one or more payments, wherein non-actionable payments comprise payments that cannot be made by the requested payment date.

3. The method of claim 2, further comprising:
receiving, by the web-based interface, updated payment data for each non-actionable payment of the one or more payments from the customer, wherein the updated payment data comprises updated payments to be made by the customer from the account;
determining, by the intelligent routing module, updated payment scheduling data based on the updated payment data;
transmitting, by the intelligent routing module, actionable payments of the updated payments to the payment staging engine; and
transmitting, by the payment staging engine, payment for each of the actionable payments of the updated payments via the preferred payment network for the actionable payment of the updated payments.

4. The method of claim 1, further comprising transmitting, by the web-based interface to the intelligent routing module, customer approval of the actionable payments of the one or more payments.

5. The method of claim 1, wherein receiving payment data for one or more payments to be made by the customer from the account comprises:
receiving, by the web-based interface, a payee for a payment; and
receiving, by the web-based interface, a payment amount for the payment.

6. The method of claim 5, wherein receiving payment data for one or more payments to be made by the customer from the account further comprises displaying, by the web-based interface, in response to receiving the payee and the payment amount, the earliest available payment date.

7. The method of claim 1, wherein receiving payment data for one or more payments to be made by the customer from the account comprises receiving, by the web-based interface, a file from the customer, wherein the file comprises payment data for the one or more payments.

8. The method of claim 7, wherein the customer creates a template on the web-based interface, and wherein the file is uploaded with a format that matches the template.

9. The method of claim 1, wherein the preferred payment network is one of a plurality of payment networks comprising real-time payment, same day automated clearing house payment, and automated clearing house payment.

10. A system, comprising:
a computer-implemented payment server system of a financial institution, the payment server system comprising:
a payment scheduling system comprising a web-based interface to receive payment data;
an intelligent routing module to schedule a payment based on the payment data, wherein the intelligent routing module is communicably coupled to the payment scheduling system; and
a payment staging engine to perform the scheduled payment,
wherein the payment server system is to:
receive, by the web-based interface, from a customer of the financial institution that has an account with the financial institution, payment data for one or more payments to be made by the customer from the account, wherein the payment data for the one or more payments comprises, for each of the one or more payments:
a payee;
a payment amount; and
a requested payment date;
determine, by the intelligent routing module, payment scheduling data for each of the one or more payments, wherein the payment scheduling data comprises for each of the one or more payments:
a determination whether the payment can be made by the requested payment date; and
a preferred payment network for the payment based on data regarding the payee and the requested payment date;
transmit, by the intelligent routing module, actionable payments of the one or more payments based on the payment scheduling data to the payment staging engine, wherein the actionable payments comprise payments that can be made by the requested payment date; and
transmit, by the payment staging engine, payment for each of the actionable payments via the preferred payment network for the actionable payment.

11. The system of claim 10, wherein the payment server system is further to transmit, by the intelligent routing module to the web-based interface, non-actionable payments of the one or more payments, wherein non-actionable payments comprise payments that cannot be made by the requested payment date.

12. The system of claim 11, wherein the payment server system is further to:
receive, by the web-based interface, updated payment data for each non-actionable payment of the one or more payments from the customer, wherein the updated payment data comprises updated payments to be made by the customer from the account;
determine, by the intelligent routing module, updated payment scheduling data based on the updated payment data;
transmit, by the intelligent routing module, actionable payments of the updated payments to the payment staging engine; and
transmit, by the payment staging engine, payment for each of the actionable payments of the updated payments via the preferred payment network for the actionable payment of the updated payments.

13. The system of claim 10, wherein the payment server system is further to transmit, by the web-based interface to the intelligent routing module, customer approval of the payments of the actionable payments.

14. The system of claim 10, wherein the customer provides payment data for a payment by entering information into payment data fields in the web-based interface.

15. The system of claim 14, wherein the payment server system is to display, by the web-based interface, in response to receiving the payee and the payment amount, the earliest available payment date to the customer.

16. The system of claim 10, wherein receive payment data for one or more payments to be made by the customer from the account comprises receive, by the web-based interface, a file from the customer, wherein the file comprises payment data for the one or more payments.

17. The system of claim 16, wherein the customer creates a template on the web-based interface, and wherein the file is uploaded with a format that matches the template.

18. The system of claim 10, wherein the preferred payment network is one of a plurality of payment networks comprising real-time payment, same day automated clearing house payment, and automated clearing house payment.
